(19) United States
(12) Patent Application Publication
(10) Pub. No.: US 2002/0091560 A1
(43) Pub. Date: Jul. 11, 2002

(54) Work flow management method and system and processing program thereof

(76) Inventors: Atsuhito Suzuki, Yokohama (JP); Nobuo Beniyama, Kawasaki (JP); Takato Kusama, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/059,327

(22) Filed: Jan. 31, 2002

Related U.S. Application Data
(63) Continuation-in-part of application No. 09/908,590, filed on Jul. 20, 2001.

(30) Foreign Application Priority Data
Jul. 11, 2001 (JP) 2001-210147
Dec. 20, 2000 (JP) 2000-391835

(51) Int. Cl. G06F 17/60

(52) U.S. Cl. 705/9; 705/11

(57) ABSTRACT

In an application service provider for controlling and managing business processes using a workflow management system, and providing functions for total businesses comprised of a plurality of activities processed by a plurality of applications, the workflow management system permits the provider to make meticulous settings and defines pricing schemes which are readily understood by users. The workflow management system has the steps of holding process definition information for defining a plurality of activities in a process and a processing sequence between the activities, managing the execution of the activities based on the process definition information to record the activity execution history as workflow execution history information, and calculating a pricing amount from the workflow execution history information based on activity set pricing scheme definition information for storing an activity set including a plurality of activity definitions in correspondence to a pricing scheme for the execution of the activity set.

### CROSS-REFERENCE TO RELATED APPLICATIONS

This application is a CIP application of U.S. patent application Ser. No. 09/908,590 entitled “WORK FLOW MANAGEMENT METHOD AND WORK FLOW MANAGEMENT SYSTEM OF CONTROLLING A WORK FLOW” and filed Jul. 20, 2001 by N. BENIYAMA et al., the contents of which are herein incorporated by reference.

### BACKGROUND OF THE INVENTION

The present invention relates to workflow management technologies involved in pricing calculations in the provision of business application services based on a workflow management system.

In recent years, ASP (Application Service Provider) has been utilized in common as a solution for realizing earlier inauguration of business applications, and a reduction in costs caused by an initial investment during the introduction and the operation of such applications in enterprises.

A workflow management system is a technology for previously defining a flow of a business process comprised of a plurality of activities as a process definition to support the management of activity performance and progress state of the business process based on the definition. The process definition may be regarded as modelling of a business flow which is the flow of the business process. While processing in each activity may be performed by a person or automatically by a business application, the workflow management system controls the assignment of these activities to human resources, and execution of the processing by business applications, as well as manages the state and advancement of the overall business flow.

A known example related to the use of a workflow management system for pricing calculations is found in JP-A-10-326314 which describes pricing calculations for outsourcing of a workflow management system itself.

At present, ASP-based pricing methods are generally conducted in units of business processes (fixed pricing per period, charge proportional to the number of processed cases, and the like), or in units of used application functions.

The pricing in units of business processes is advantageous in that it is readily understood by users. However, when a business flow includes branches, the quality and quantity of services actually provided to users may differ depending on the direction in which the business flow is branched, leading to different amounts of resources consumed for providing services in a provider. Particularly, when a portion of a business flow includes a high value added service (advanced application, consulting service, execution of business processing at the provider, and the like), such a service significantly affects the amount of resources used therefor.

The pricing in units of used application functions can reflect on the quality and quantity of services actually provided to users, and the amount of consumed resources at a provider. Disadvantageously, however, this pricing is not readily understood by users who make contracts with the provider in units of business processes, and the provider is burdened with complicated pricing management.

### SUMMARY OF THE INVENTION

It is an object of the present invention to provide a workflow management system and method which permits a provider, responsible for providing a user system with business services, to define user-friendly pricing.

It is another object of the present invention to provide a provider which permits users to customize a pricing scheme in consideration of the characteristics of their respective business processes.

In accordance with the foregoing objects, the present invention provides a method of managing a workflow based on process definition information. The method comprises the steps of:

managing execution of a plurality of activities in a process based on process definition information which defines the plurality of activities and a processing sequence between the plurality of activities, and holding execution history information on the plurality of executed activities;

corresponding an activity set included in a workflow defined by the process definition information to a pricing scheme for a user associated with the execution of the activity set, and holding the correspondence as activity set pricing definition information; and

calculating a pricing amount for the user based on the activity set pricing definition information.

The present invention also provides a workflow management program which is read into and run on an apparatus for managing a workflow based on process definition information, comprising the steps of:

managing execution of a plurality of activities in a process based on process definition information which the plurality of activities and a processing sequence between the plurality of activities, and holding execution history information on the plurality of executed activities;

corresponding an arbitrary activity set included in a workflow defined by the process definition information to a pricing scheme for a user associated with the execution of the activity set, and holding the correspondence as activity set pricing definition information; and

calculating a pricing amount for the user based on the activity set pricing definition information.

A pricing calculation can be conducted for each user based on a pricing scheme defined for an activity set of a process flow which includes at least one activity definition from workflow execution history information. Also, the user can select a pricing scheme for an activity set which includes one or a plurality of activity definitions in consideration of the characteristics of each business process, using a plurality of pricing schemes defined for respective activity sets of the process flow.

### BRIEF DESCRIPTION OF THE DRAWINGS

FIG. 1 is a block diagram illustrating the configuration of an ASP system which provides high value-added services in accordance with an embodiment of the present invention;

FIG. 2 is a block diagram illustrating the system configuration of a workflow management system in an embodiment of the present invention;

FIG. 3 is a flow diagram illustrating an exemplary process definition for the workflow management system in the embodiment of the present invention;

FIG. 4 shows a tabular structure of a process definition 0121 in FIG. 2;

FIG. 5 shows a tabular structure of case information 0122 in FIG. 2;

FIG. 6 is a flow diagram illustrating an exemplary pricing definition in another embodiment;

FIG. 7 shows a tabular structure and contents of a pricing definition 0124 in FIG. 12 in another embodiment;

FIG. 8 is a flow chart illustrating the operation of a pricing calculation program 0161 in another embodiment;

FIGS. 9A and 9B are flow charts illustrating the operation for calculating a pricing amount for each pricing scheme setting unit 0801 in the processing of the pricing calculation program 0161;

FIG. 10 is a flow diagram illustrating a pricing definition in a further embodiment;

FIG. 11 shows a tabular structure and contents of the pricing definition 0124 in FIG. 2 in a further embodiment; and

FIG. 12 is a flow chart illustrating the operation of the pricing calculation program 0161 in a further embodiment.

### DETAILED DESCRIPTION OF THE EMBODIMENTS

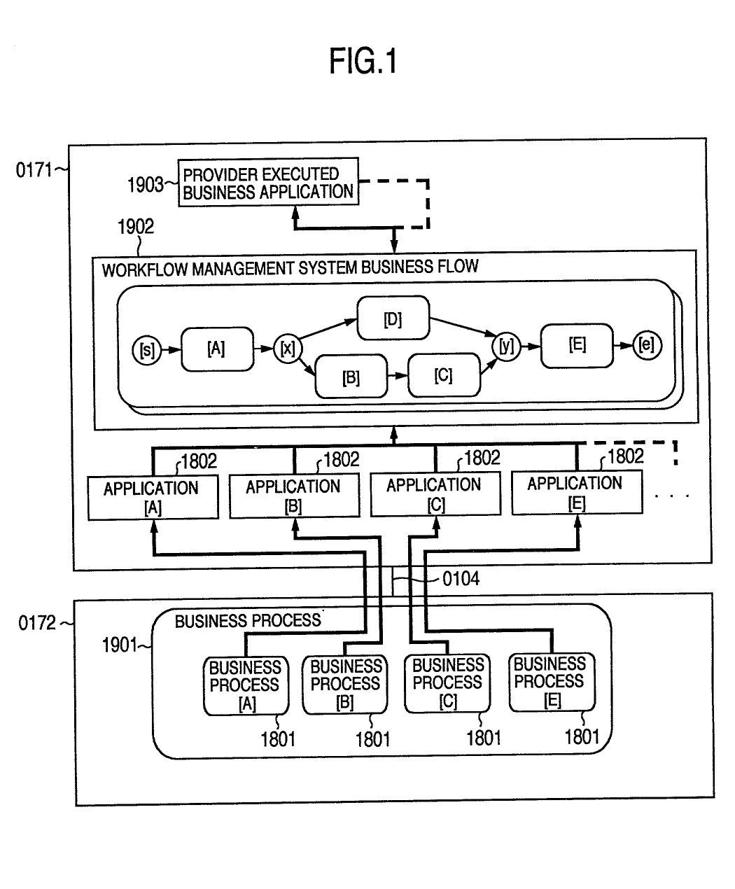

A provider in an ASP system illustrated in FIG. 1 operates and manages a provider computing environment 0171 which has installed therein applications 1802 for users at a proprietary computer center or another company's computer center, and a user accesses an application 1802, for which the user has made a contract with the provider, from a user computer environment 0172 through a network 0104 to execute a business process 1801. With this system, the user need not introduce a server machine by himself to operate and manage an application system and can leave version-up and the like of the OS and applications to the provider. A workflow management system 1902 can be used as an infrastructure to entirely control and manage business processes, and provides higher value-added services such as the provision of full functions for a business process 1901 comprised of a plurality of activities processed by a plurality of applications, the execution of the entire business process on the provider side (provider execution business application 1903), and the like. A workflow managed by the workflow management system 1902 (business flow [1]) comprises activities [A], [B], [C], [E] executed from the user computing environment 0172 by the user who manipulates applications 1802[A], [B], [C], [E], and an activity [D] executed by a provider executed business application 1903[D] without requiring user's manipulations. In such a case, detailed and appropriate pricing is desirably conducted for individual cases in accordance with the amount and quality of used services.

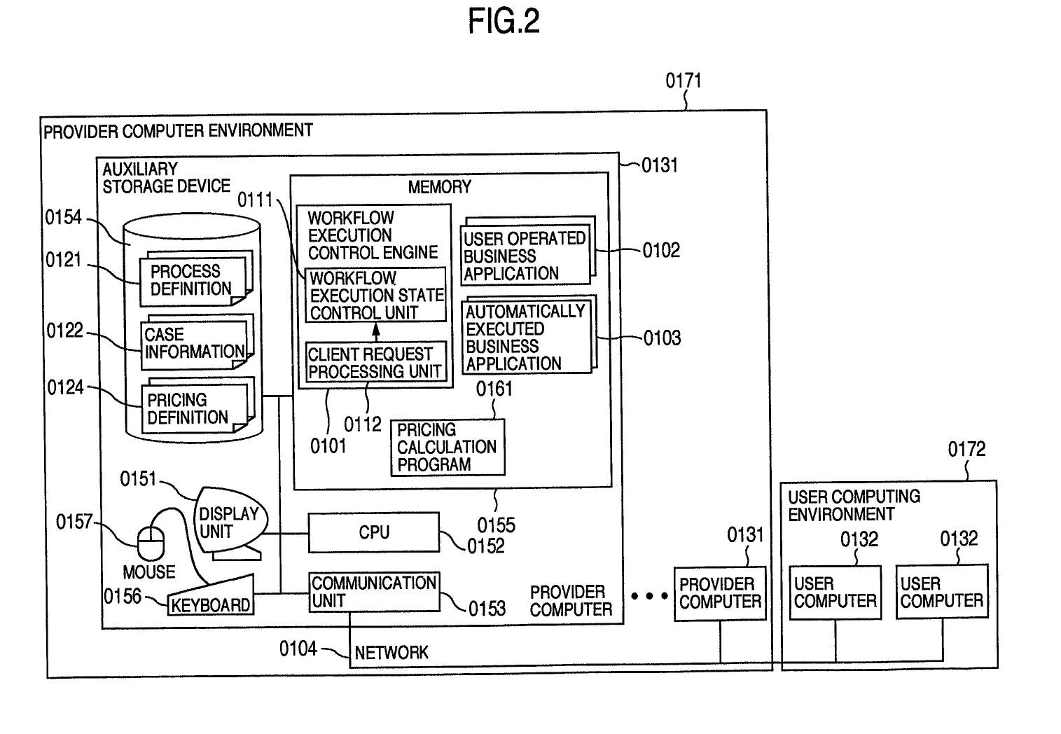

FIG. 2 illustrates an exemplary configuration of a workflow management system according to the present invention. A provider computer 0131 resides in the provider computing environment 0171, and a user computer 0132 resides in the user computing environment 0172, respectively.

The provider computer 0131 comprises hardware components such as a display unit 0151, a CPU 0152, a communication unit 0153, an auxiliary storage device 0154, a memory 0155, a keyboard 0156, and a mouse 0157. While FIG. 2 only depicts details of the internal configuration in portions of the provider computer 0131 for simplicity, other provider computers 0131 and user computers 0132 may comprise a similar hardware configuration. A workflow execution control engine 0101, a user-operated business application 0102, and an automatically executed business application 0103 are software programs which run on the provider computer 0131. These software programs are stored in the auxiliary storage device 0154, and read into the memory 0155 upon execution, and executed by the CPU 0152. Also, these software programs can interact with a human participant through a man-machine interface using the display unit 0151, and an input device such as the keyboard 0156, mouse 0157 and the like, or can mutually communicate with software programs running on other computers using the communication unit 0153. Further, each of these programs may be installed on the same provider computer 0131 or on different provider computers 131 interconnected through the network 0104.

The workflow execution control engine 0101 manages the execution states for activities and business flows based on a process definition 0121 which describes a processing procedure for predefined activities. The workflow execution control engine 0101 also accepts a processing request for the user-operated business application 0102 or automatically executed business application 0103. The workflow execution control engine 0101 also transmits a processing request for the automatically executed business application 0103 as required. The operation of the workflow execution control engine 0101 will be described later.

The user-operated business application 0102 is manipulated by the participant from the user computer 0132 through the network 0104 to acquire and display a list of activities allocated to the participant from the workflow execution control engine 0101, and to process the allocated activities. The automatically executed business application 0103 accepts a processing execution request for activities from the workflow execution control engine 0101 and executes the processing for the activities without intervention of human's hands. Also, the user-operated business application 0102 and automatically executed business application 0103 notify the workflow execution control engine 0101 of start, suspension, resumption and completion of processing associated with any activity.

The pricing calculation program 0161 conducts pricing calculations for each user based on pricing definition 0124 which previously defines a pricing scheme applied to the usage of the system, and the contents of a contract with the user. The operation of the pricing calculation program 0161 will be described later.

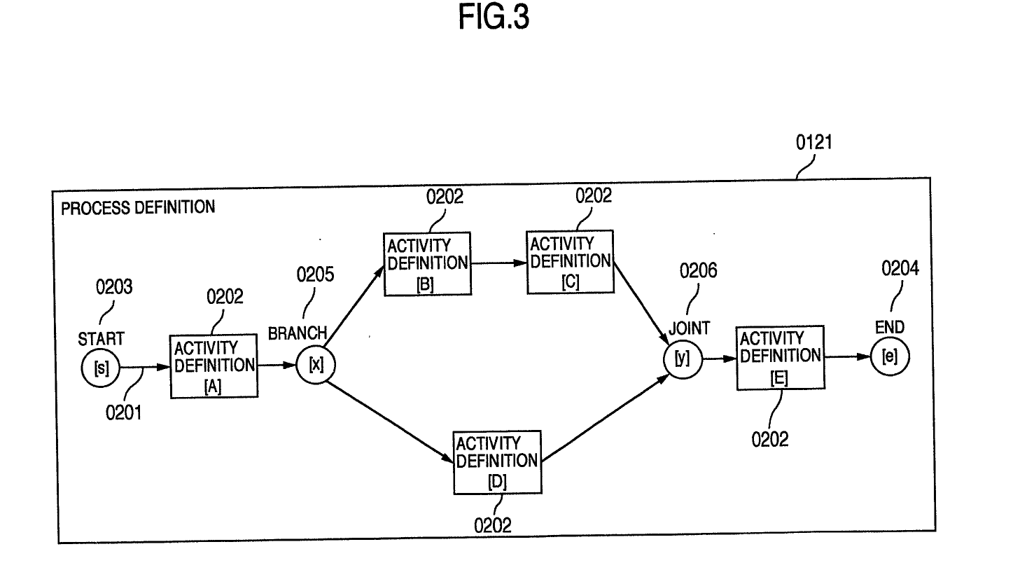

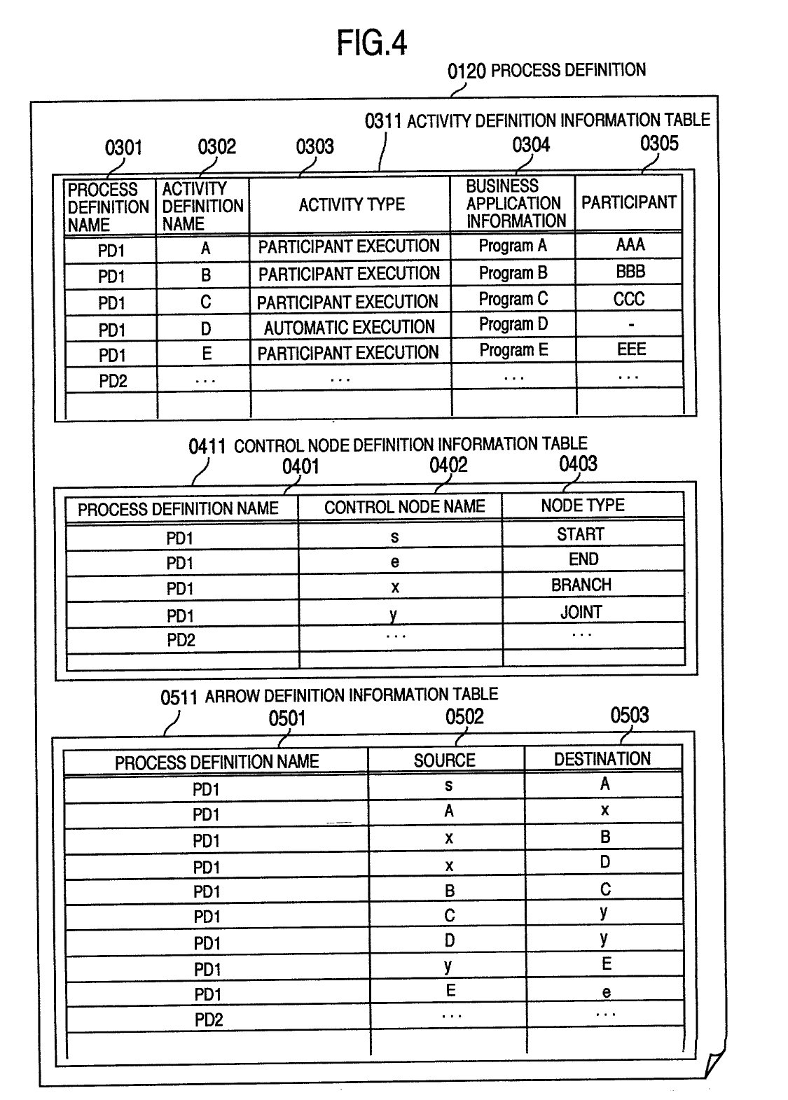

A plurality of the predefined process definitions 0121 can be stored in the auxiliary storage device 0154. FIG. 3 illustrates a concept of definitions in the process definition 0121. The process definition 0121 is represented as a directed graph which connects a plurality of activity definitions 0202 with arrows 0201. A start point, an end point, a branch point and a joint point of the graph are represented by special nodes, called control nodes, on the directed graph. Nodes 0203—0206 in FIG. 2 are the control nodes which represent the start node 0203, end node 0204, branch node 0205 and joint node 0206, respectively. The directed graph starts at the start node 0203 and ends at the end node 0204. FIG. 4 shows details on the process definition 0121 illustrated in FIG. 3, and a format for the process definition 0121 when it is stored in the auxiliary storage device 0154. The process definition 0121 is comprised of an activity definition information table 0311 for storing definition information on the activity definitions 0202 included in the process definition 0121; a control node definition information table 0411 for storing definition information on control nodes included in the process definition 0121; and an arrow definition information table 0511 for storing definition information on arrows 0201 which connect between the activity definitions 0202 and control nodes 0203—0206. Since either of the tables stores information on a plurality of process definitions 0121, the table has a process definition name on the first column (columns 0301, 0401, 0501 in the respective figures) for identifying a particular process definition 0121 to which definition information belongs. In the following, columns of the respective tables will be described in detail for each of the figures.

In the activity definition information table 0311, an activity definition name 0302 is a name for uniquely identifying an activity definition 0202 associated with the same process definition name. An activity type 0303 may take one of two values, “participant execution” and “automatic execution” for specifying whether the processing for an activity in the activity definition is executed by a human participant through manipulations on the user operated business application 0102 (“participant execution”) or executed without intervention of the human participant by the workflow execution control engine 0101 which issues a processing request to the automatically executed business application 0103 (“automatic execution”). Business application information 0304 specifies information for identifying a business application which should process a particular activity. A participant 0305 specifies information for identifying a participant who is to process the activity when the activity type 0303 indicates “participant execution.”

In the control node definition information table 0411, a control node name 0402 is a name for uniquely identifying definition information for the control nodes 0203—0206 associated with the same process definition name. A node type 0403 may take one of four values “start,” “end,” “branch” and “joint” for indicating the type of the associated control node.

In the arrow definition information table 0511, a source 0502 and a destination 0503 each specify an activity definition name 0302 or a control node name 0402 of two activity definitions 0202 or control nodes 0203—0206, when connected by an arrow 0201.

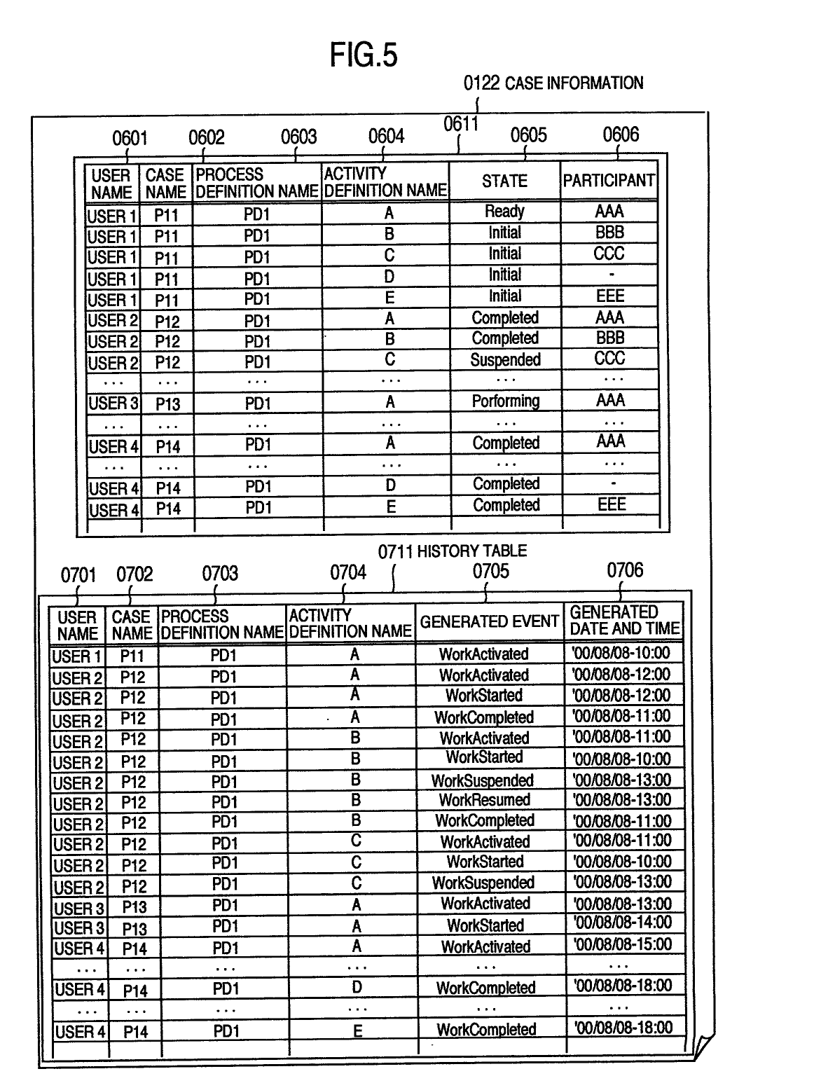

Case information 0122 stores the execution state and execution history for activities and business flow in the auxiliary storage device 0154 in the activity and business flow execution state management made by the workflow execution control engine 0101. FIG. 5 shows in detail a format in which the case information 0122 is stored in the auxiliary storage device 0154.

Each record in the state management table 0611 holds the state of each activity within a case. A user name 0601 is the name of a user who has introduced each case. A case name 0602 is a name for uniquely identifying each of cases associated with the same user name. A process definition name 0603 indicates a process definition 0121 which is a model of the case. An activity definition name 0604 identifies an activity definition 0202 which is a model of an activity, the state of which is held. A state 0605 represents the execution state of an activity, and may take one of five values, “Initial,” “Ready,” “Performing,” “Suspended” and “Completed.” The “Initial” state indicates the initial state of an activity, and is taken by all activities at the outset of the case. The “Ready” state indicates that the processing for an activity can be started. The “Performing” state indicates that the processing for an activity is under execution. The “Suspended” state indicates that the processing for an activity is suspended. The “Completed” state indicates the completion of the processing for an activity. A participant 606 is the name of a participant who is to perform an activity when the activity type is “participant execution.”

Each record in a history table 0711 holds information related to generated events in the execution state management conducted by the workflow execution control engine 0101. A user name 0701 indicates the name of a user who has introduced a case in which an event is generated. A case name 0702 is a name for uniquely identifying each of cases associated with the same user name. A process definition name 0703 indicates a process definition 0121 which is a model of the case. An activity definition name 0704 identifies an activity definition 0202 which is a model of an activity in which an event is generated. A generated event 0705 represents the type of a generated event, and may take one of five values: “WorkActivated,” “WorkStarted,” “WorkSuspended,” “WorkResumed,” and “WorkCompleted.” “WorkActivated” indicates that the state 0605 of an activity has been changed from “Initial” to “Ready”; “WorkStarted” from “Ready” to “Performing”; “WorkSuspended” from “Performing” to “Suspended”; “WorkResumed” from “Suspended” to “Performing”; and “WorkCompleted” from “Performing” to “Completed”, respectively. A generated date and time 0706 indicates the date and time at which the event is generated.

Next, the operation of the workflow execution control engine 0101 will be described with reference again to FIG. 2.

As illustrated in FIG. 2, the workflow execution control engine 0101 is comprised of sub-programs, i.e., a workflow execution state control unit 0111 and a client request processing unit 0112.

The client request processing unit 0112 accepts from the user operated business application 0102 and automatically executed business application 0103 six types of commands: an activity list acquisition command “GetWorkList,” an activity start notification command “StartWork,” an activity suspension notification command “SuspendWork,” an activity resumption notification command “ResumeWork,” an activity completion notification command “CompleteWork” and a case start command “StartProcess.”

The “GetWorkList” command receives a user name and a participant name as inputs, and outputs an activity name list which enumerates activities assigned to the participant. The “StartProcess” command receives a user name, a case name and a process definition name as inputs, and requests the workflow execution state control unit 0111 to start a case in a specified process definition with the specified case name. Each of the “StartWork,” “SuspendWork,” “ResumeWork,” and “CompleteWork” commands receives a user name, a case name and an activity definition name as inputs, and notifies the workflow execution state control unit 0111 of the start, suspension, resumption or completion of processing involved in an activity for the specified activity definition name of a specified case.

The workflow execution state control unit 0111 appropriately changes the state management table 0611 in accordance with the process definition 0121 in response to the “StartProcess” command and each of the “StartWork,” “SuspendWork,” “ResumeWork” and “CompleteWork” commands accepted by the client request processing unit 0112, and records events associated with these commands in the history table 0711. An event is recorded in the history table 0711 by inserting the user name 0601, case name 0602, process definition name 0603 and activity definition name 0604 of an activity in which the event is generated, the type of the generated event, the date and time at which the event is generated into the history table 0711. The date and time can be acquired, for example, by invoking a system call provided by the operating system. Upon accepting the “StartProcess” command, the workflow execution state control unit 0111 searches the activity definition information table 0311 for information on each activity definition 0202 defined in the specified process definition 0121, using the process definition name 0301 as a key, and inserts a record of an activity corresponding to each activity definition 0202 into the state management table 0611. In this event, the state 0605 for each activity is set to the “Initial” state. Also, the workflow execution state control unit 0111 sets a user name, a case name and a process definition name, specified upon acceptance of a command, in the respective columns labeled the user name 0601, case name 0602 and process definition name 0603, respectively, and sets the activity definition name 0302 and participant 0305, which are attribute information of the activity definition 0202 corresponding to the record, in respective columns labeled the activity definition name 0604 and participant 0606. Further, the workflow execution state control unit 0111 determines the activity definition 0202 which should be first executed, tracing from the start node 0203 along the directed graph for the process definition 0121, and changes the state 0605 for an activity corresponding to the activity definition from the “Initial” state to the “Ready” state. Then, a “WorkActivated” event associated with the activity is recorded in the history table 0711. In this event, if the activity type 0303 of the activity definition 0202 is “automatic execution,” the workflow execution state control unit 0111 transmits a request for executing the processing for the activity to an automatically executed business application 0103 identified by the business application information 0304. The execution request includes information related to the activity (user name 0601, case name 0602, process definition name 0603, activity definition name 0604). Also, the business application information 0304 can be acquired by searching the activity definition information table 0311 for activity definition information related to the activity, using the process definition name 0301 and activity definition name 0302 as keys. Upon accepting each of the “StartWork,” “SuspendWork” and “ResumeWork” commands, the state of a specified activity is changed from “Ready” to “Performing” when “StartWork” is accepted; from “Performing” to “Suspended” when “SuspendedWork” is accepted; and from “Suspended” to “Performing” when “ResumeWork” is accepted, and an event corresponding to the executed change in the state, associated with the activity, is recorded in the history table 0711. Upon accepting the “CompleteWork” command, the workflow execution state control unit 0111 changes the state of an activity for a specified activity definition of a specified case from the “Performing” state to the “Completed” state, records an “WorkCompleted” event associated with the activity in the history table 0711, determines an activity definition to be executed next to the current activity definition in accordance with the directed graph of the process definition 0121, changes the state 0605 of the activity for the activity definition to be next executed from the “Initial” state to the “Ready” state, and records a “WorkActivated” event associated with the activity in the history table 0711. In this event, if the activity type 0303 is set to “automatic execution,” the workflow execution state control unit 0111 transmits a request for executing the processing for the activity to an automatic executed business application 0103 identified by the business application information 0304, as described above.

Next, the operation of the pricing calculation program 0161 will be described. The pricing calculation program 0161 is initiated by the provider through the provider computer 0131 or by the user from the user computer 0132 through the network 0104 as required, and conducts pricing calculations for each user based on the pricing definition 0124 which previously defines a pricing scheme applied to the use of the system and the contents of a contract with the user, with reference to the history table 0711 which records the history of the workflow execution control.

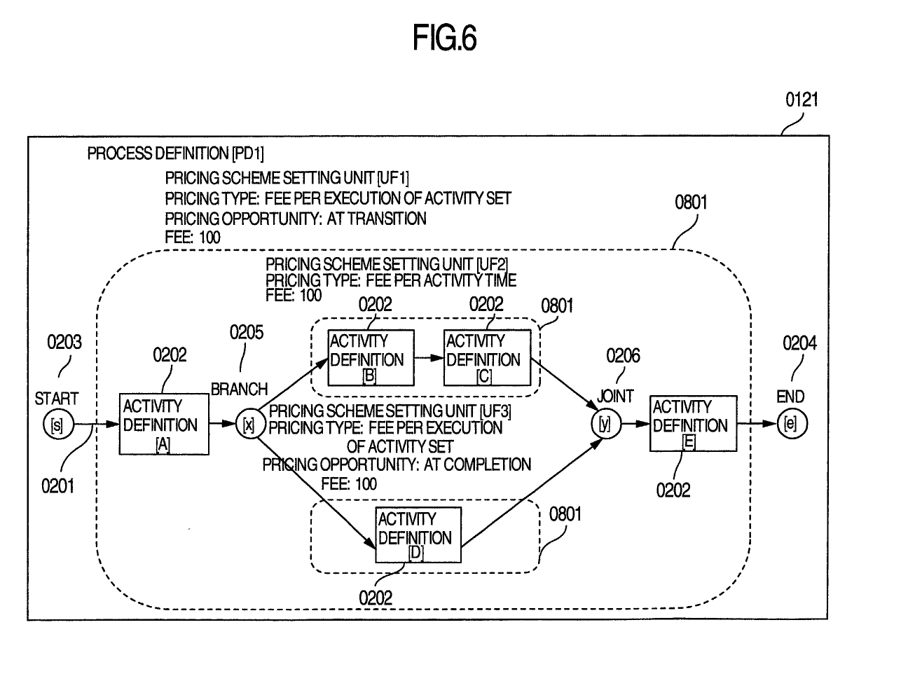

FIG. 6 shows a method of defining the pricing definition 0124, and an example of specific definitions in this embodiment. The pricing definition 0124 defines a pricing scheme applied to the execution of an activity set or activity set of the process definitions 0121 which have been defined and registered in the workflow management system. First, the pricing calculation program 0161 defines a activity set of a process definition 0121, comprised of a set of one or more activity definitions 0202. The activity set is called a pricing scheme setting unit 0801. Next, the program 0161 specifies a pricing scheme applied to the execution of a activity set corresponding to each pricing scheme setting unit 0801. For specifying the pricing scheme, a pricing type and fee are specified. The pricing type can be specified from the following three: “fee per execution of activity set (pricing in accordance with the number of times the activity set is passed)”, “fee per activity time (pricing in accordance with an activity execution time within the activity set)” and “fixed fee (pricing per contract irrespective of the execution of the activity set)”. When “fee per execution of activity set” is specified as the pricing type, a pricing opportunity is specified as a timing of counting the passage of the activity set. The pricing opportunity can be specified from the following two: “transition (a timing at which the first activity included in the activity set can be started)” and “completion (a timing at which the last activity included in the activity set is completed)”. In FIG. 6, the specified contents of the pricing scheme are described above each pricing scheme setting unit 0801.

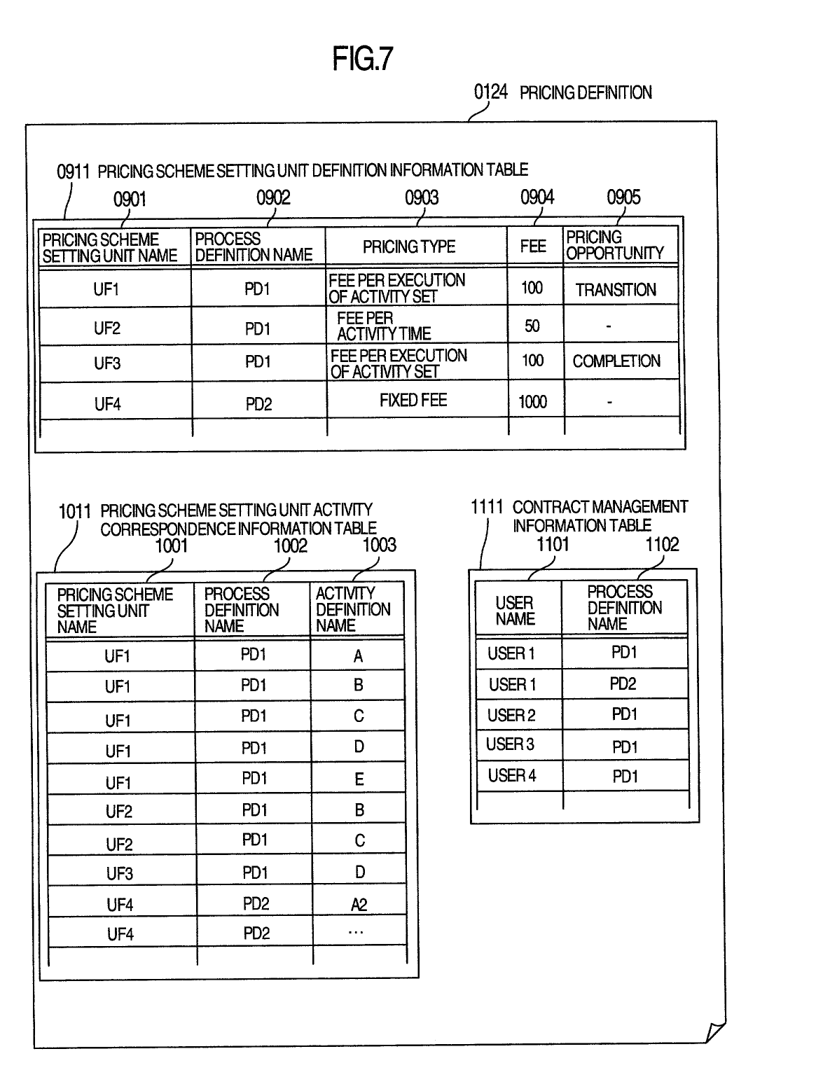

FIG. 7 shows a format in which the pricing definition 0124 is stored in the auxiliary storage device 0154, and how the exemplary definitions shown in FIG. 6 are stored. The pricing definition 0124 is comprised of a pricing scheme setting unit definition information table 0911 for storing definition information on pricing scheme setting units 0801 included in the pricing definition 0124; a pricing scheme setting unit activity correspondence information table 1011 for storing information on a correspondence of each pricing scheme setting unit 0801 to a constituent activity definition 0202; and a contract management information table 1111 for holding a correspondence of a user name to a process definition 0121 for which the user has made a contract.

In the pricing scheme setting unit definition information table 0911, a pricing scheme setting unit name 0901 is a name for uniquely identifying a pricing scheme setting unit 0801 associated with the same process definition name. A process definition name 0902 represents a process definition 0121 which includes the pricing scheme setting unit 0801. A pricing type 0903 is a value for specifying the type of pricing scheme, and may take one of the following three values: “fee per execution of activity set,” “fee per activity time” and “fixed fee.” A fee 0904 indicates the pricing amount for one unit of pricing determined by specifying the pricing type 0903. A pricing opportunity 0905 is a value for specifying a timing at which a passage of a activity set is counted, when the pricing type 0903 is specified as “fee per execution of activity set,” and may take one of the following two values: “transition” and “completion.”

In the pricing scheme setting unit activity correspondence information table 1011, a pricing scheme setting unit name 1001 is a name for uniquely identifying a pricing scheme setting unit 0801 associated with the same process definition name. A process definition name 1002 and an activity definition name 1003 are provided for uniquely identifying an activity definition 0202 included in the pricing scheme setting unit 0801.

Each of records in the contract management information table 1111 holds a correspondence of a user name to a process definition 0121 for which the user has made a contract. A user name 1101 represents a user who has made a contract. A process definition name 1102 is a name for uniquely identifying a process definition 0121 corresponding to a business process for which the user has made a contract.

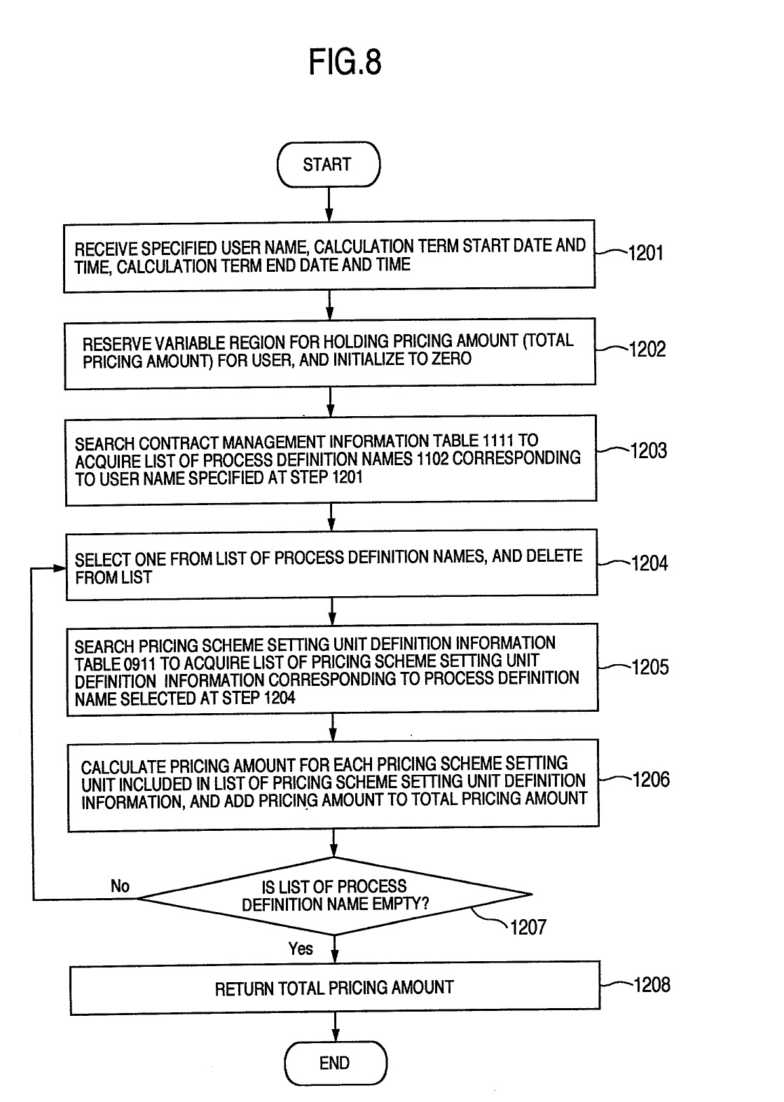

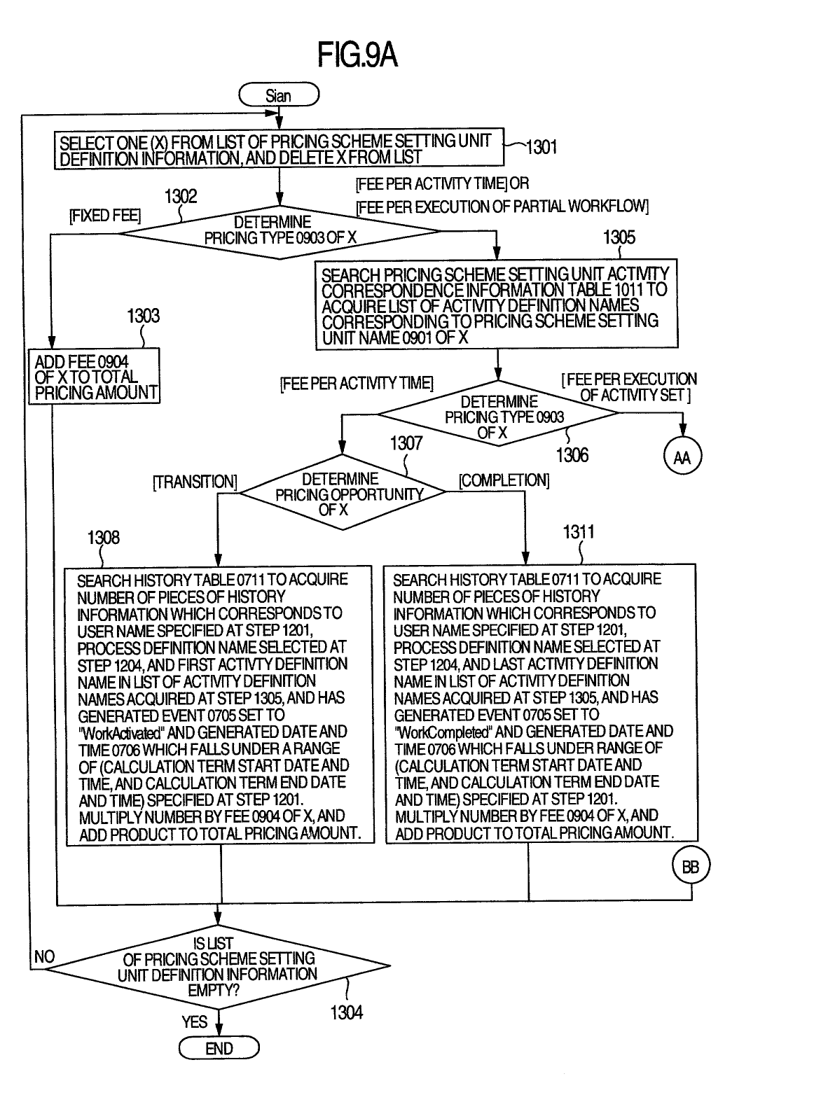

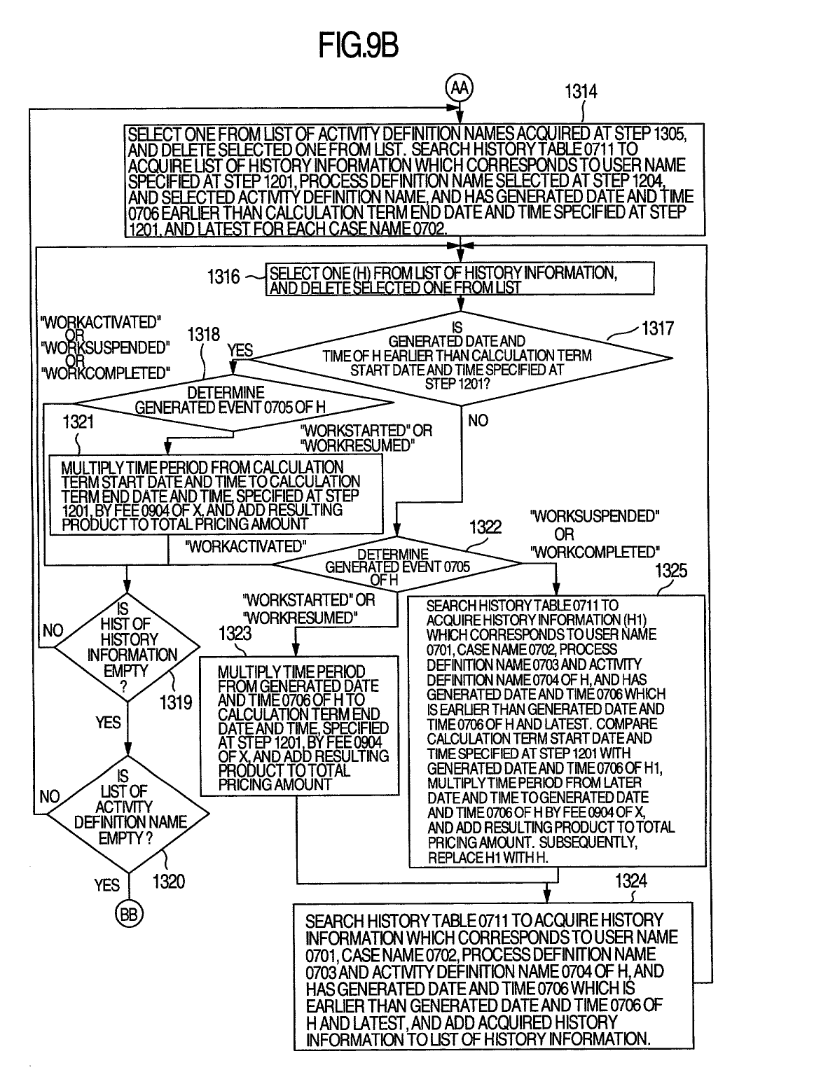

In the following, a detailed processing procedure of the pricing calculation program 0161 will be shown with reference to flow charts of FIGS. 8, 9A and 9B.

In a processing procedure illustrated in FIG. 8, a set of process definitions 0121 corresponding to a business process, for which the user has made a contract, is identified from the user name, and a pricing calculation is conducted for each pricing scheme setting unit 0801 included in each process definition 0121 to determine the pricing amount for the user. In the following, each step will be described in detail along the flow. (Step 1201) The pricing calculation program 0161, when initiated, receives, the specified user name subjected to the pricing calculation, and a term for which the pricing calculation is conducted (calculation term start date and time, and calculation term end date and time). (Step 1202) The program 0161 reserves a variable region for holding a pricing amount for the user (total pricing amount), and initializes the variable to zero. (Step 1203) The program 0161 searches the contract management information table 1111 to acquire a list of process definition names 1102 corresponding to the user name specified at step 1201. (Step 1204) The program 0161 selects one from the list of process definition names acquired at step 1203, and deletes the selected process definition name from the list. (Step 1205) The program searches the pricing scheme setting unit definition information table 0911 to acquire a list of pricing scheme setting unit definition information corresponding to the process definition name selected at step 1204. (Step 1206) The program 0161 calculates a pricing amount for each pricing scheme setting unit in the list of pricing scheme setting unit definition information acquired at step 1205, and adds the pricing amount to the total pricing amount. The processing at this step will be described later in detail in a flow chart of FIGS. 9A and 9B. (Step 1207) The program 0161 determines whether or not the list of process definition names is empty, and proceeds to step 1208 when the list is empty. Otherwise, the program 0161 proceeds to step 1204. (Step 1208) The program 0161 calls the total pricing amount, returns it to the requester, and terminates.

In the processing illustrated in FIGS. 9A and 9B, a pricing amount is calculated for each pricing scheme setting unit 0801 within the set of pricing scheme setting units 0801 acquired in FIG. 8, and added to the total pricing amount. The processing flows in FIGS. 9A and 9B illustrate the processing at step 1206 in FIG. 8 in detail. In the following, each step will be described along the flow. (Step 1301) The pricing calculation program 0161 selects one piece of pricing scheme setting unit definition information (hereinafter, represented by “X”) from the list of pricing scheme setting unit definition information, and deletes X from the list. (Step 1302) The program 0161 determines the pricing type 0903 of X, and proceeds to step 1303 when the pricing type 0903 is set to “fixed fee.” The program 0161 proceeds to step 1305 when the pricing type 0903 is set to “fee per execution of activity set” or “fee per activity time.” (Step 1303) The fee 0904 of X is added to the total pricing amount. (Step 1304) The program 0161 determines whether or not the list of pricing scheme setting unit definition information is empty, and proceeds to step 1301 when it is not empty. The program 0161 proceeds to Step 1207 in FIG. 8 when the list is empty. (Step 1305) The program 0161 searches the pricing scheme setting unit activity correspondence information table 1011 to acquire a list of activity definition names corresponding to the pricing scheme setting unit name 0901 of X. (Step 1306) The program 0161 determines the pricing type 0903 of X, and proceeds to step 1307 when the pricing type 0903 is set to “fee per execution of activity set.” The program 0161 proceeds to step 1314 when the pricing type 0903 is set to “fee per activity time.” (Step 1307) The program 0161 determines the pricing opportunity 0905 of X, and proceeds to step 1308 when the pricing opportunity 0905 is set to “transition.” The program 0161 proceeds to step 1311 when the pricing opportunity 0905 is set to “completion.” (Step 1308) The program 0161 searches the history table 0711 to acquire the number of pieces of history information which corresponds to the user name specified at step 1201, the process definition name selected at step 1204, and the first activity definition name (which has been acquired by searching the arrow definition information table 0511) in the list of activity definition names acquired at step 1305, and has the generated event 0705 set to “WorkActivated” and the generated date and time 0706 which falls under a range of (the calculation term start date and time, and calculation term end date and time) specified at step 1201. Then, the program 0161 multiplies the number of pieces of history information by the fee 0904 of X, adds the product to the total pricing amount, and proceeds to step 1304. (Step 1311) The program 0161 searches the history table 0711 to acquire the number of pieces of history information which corresponds to the user name specified at step 1201, the process definition name selected at step 1204, and the last activity definition name (which has been acquired by searching the arrow definition information table 0511) in the list of activity definition names acquired at step 1305, and has the generated event 0705 set to “WorkCompleted” and the generated date and time 0706 which falls under a range of (the calculation term start date and time, and calculation term end date and time) specified at step 1201. Then, the program 0161 multiplies the number of pieces of history information by the fee 0904 of X, adds the product to the total pricing amount, and proceeds to step 1304. (Step 1314) The program 0161 selects one activity definition name from the list of activity definition names acquired at step 1305, and deletes the selected one from the list. The program 0161 searches the history table 0711 to acquire a list of history information which corresponds to the user name specified at step 1201, the process definition name selected at step 1204, and the selected activity definition name, and has the generated date and time 0706 earlier than the calculation term end date and time specified at step 1201, and the latest for each case name 0702. (Step 1316) The program 0161 selects one history information (hereinafter represented by “H”) from the list of history information acquired at step 1314, and deletes the selected history information from the list. (Step 1317) The program 0161 determines whether or not the generated date and time 0706 of H is earlier than the calculation term start date and time specified at step 1201, and proceeds to step 1318 when earlier. Otherwise, the program 0161 proceeds to step 1322. (Step 1318) The program 0161 determines the generated event 0705 of H, and proceeds to step 1319 when the generated event 0705 is set to “WorkActivated” or “WorkSuspended” or “WorkCompleted.” The program 0161 proceeds to step 1321 when the generated event 0705 is set to “WorkStarted” or “WorkResumed.” (Step 1319) The program 0161 determines whether or not the list of history information is empty, and proceeds to step 1320 when the list is empty. The program 0161 proceeds to step 1316 when the list is not empty. (Step 1320) The program 0161 determines whether or not the list of activity definition name is empty, and proceeds to step 1304 when the list is empty. The program 0161 proceeds to step 1314 when the list is not empty. (Step 1321) the program 0161 multiplies a time period from the calculation term start date and time to the calculation term end date and time, specified at step 1201, by the fee 0904 of X, and adds the resulting product to the total pricing amount. (Step 1322) The program 0161 determines the generated event 0705 of H, and proceeds to step 1319 when the generated event 0705 is set to “WorkActiviated.” The program 0161 proceeds to step 1323 when the generated event 0705 is set to “WorkStarted” or “WorkResumed.” The program 0616 proceeds to step 1325 when the generated event 0705 is set to “WorkSuspended” or “WorkCompleted.” (Step 1323) The program 0161 multiplies a time period from the generated date and time 0706 of H to the calculation term end date and time, specified at step 1201, by the fee 0904 of X, adds the resulting product to the total pricing amount, and proceeds to step 1324. (Step 1324) The program 0161 searches the history table 0711 to acquire history information which corresponds to the user name 0701, case name 0702, process definition name 0703 and activity definition name 0704 of H, and has the generated date and time 0706 which is earlier than the generated date and time 0706 of H and the latest, and adds the acquired history information to the list of history information. (Step 1325) The program 0161 searches the history table 0711 to acquire history information (hereinafter represented by “H1”) which corresponds to the user name 0701, case name 0702, process definition name 0703 and activity definition name 0704 of H, and has the generated date and time 0706 which is earlier than the generated date and time 0706 of H and the latest. The program 0161 compares the calculation term start date and time specified at step 1201 with the generated date and time 0706 of H1, multiplies a time period from the later date and time of the two to the generated date and time 0706 of H by the fee 0904 of X, and adds the resulting product to the total pricing amount. Then, the program 0161 replaces H1 with H.

As described above, according to the present invention, since the pricing scheme is defined associated with a business flow, this pricing scheme is readily understood by the user. In addition, since the pricing scheme can be defined for an arbitrary activity set in a business flow, the pricing scheme can be set in a meticulous manner by the provider.

In addition, according to the present invention, since the pricing information is unitarily managed as the workflow execution history information, the pricing information is readily managed by the provider.

Next, an embodiment related to the pricing scheme definition and pricing calculation will be described for allowing the user to customize the pricing scheme in consideration of the characteristics of each business process. For avoiding redundant description, the following description will be centered on differences with the first embodiment.

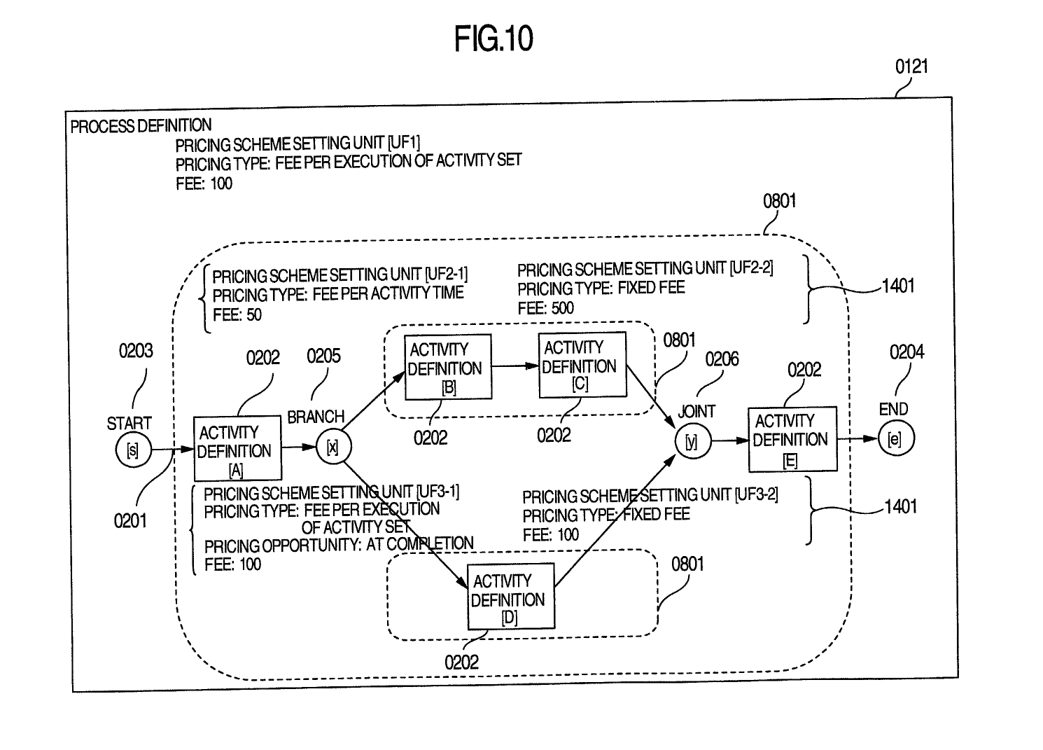

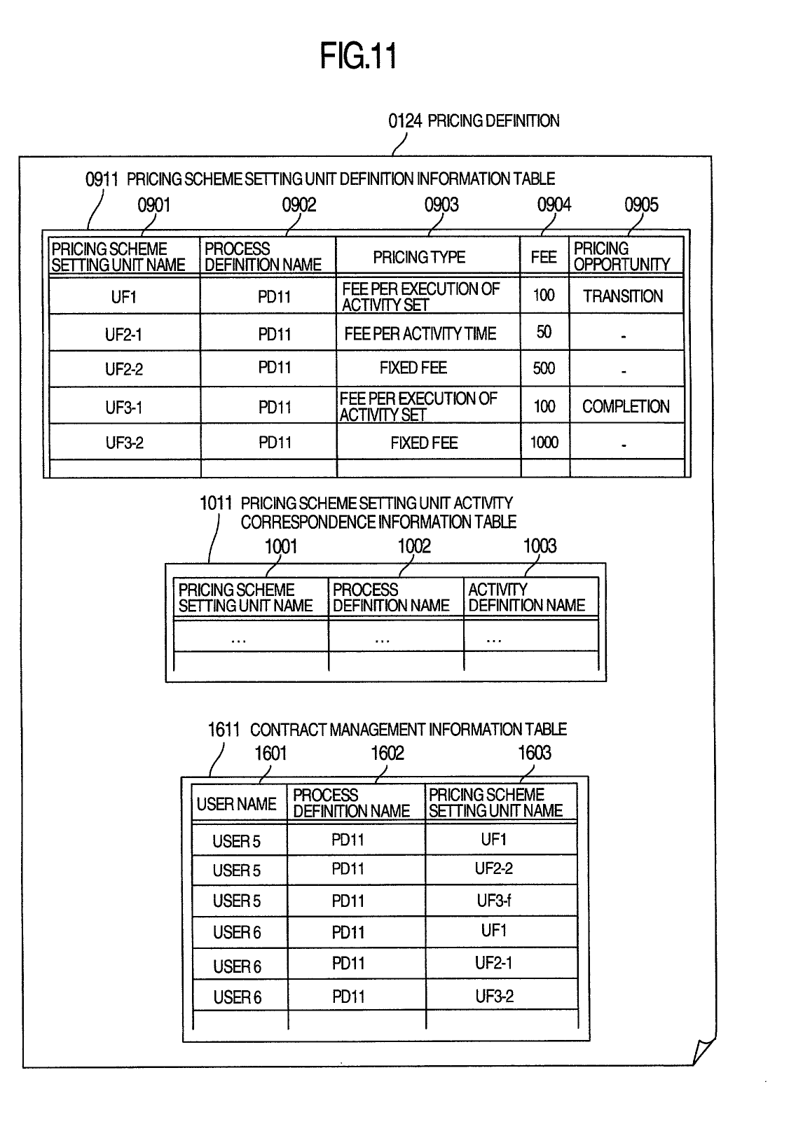

FIG. 10 illustrates a method of defining the pricing definition 0124, and an example of specific definitions in this embodiment. The pricing definition 0124 defines a plurality of optional pricing schemes for defining a pricing scheme applied to the execution of an arbitrary activity set of the process definitions 0121 which have been defined and registered in the workflow management system, and manages a correspondence relationship of the user to business processes for which the user has made a contract, and a pricing scheme applied to each business process. In this embodiment, a pricing scheme option 1401 {UF2-1 (“fee per activity time”), UF2-2 (“fixed fee”)} is defined for activity sets B, C, and a pricing scheme option 1401 {UF3-1 (“fee per execution of activity set”), UF3-2 (“fixed fee”)} is defined for a activity set D, respectively. FIG. 11 shows the exemplary definitions illustrated in FIG. 10 when they are stored.

Each of records in a contract management information table 1611 holds a correspondence of a user name to process definitions 0121 for which the user has made a contract, and a pricing scheme setting unit 0801 which indicates a pricing scheme selected by the user at the time of the contract. A user name 1601 indicates the user who has made the contract. A process definition name 1602 is a name for uniquely identifying a process definition 0121 corresponding to a business process for which the user has made a contract. A pricing scheme setting unit name 1603 is a name for uniquely identifying pricing scheme setting units 0801 associated with the same process definition name.

From user's viewpoint, it is generally advantageous to select a fixed fee pricing scheme for a activity set which is highly frequently used, and to select a variable fee pricing scheme for a activity set which is not frequently used, in terms of the cost effectiveness. In the workflow management system of this embodiment, the user can customize the contents of a contract in consideration of the characteristics of each business process (the number of cases, frequency of passages of a activity set which may vary in the paths after branching, an activity time within a activity set, and the like).

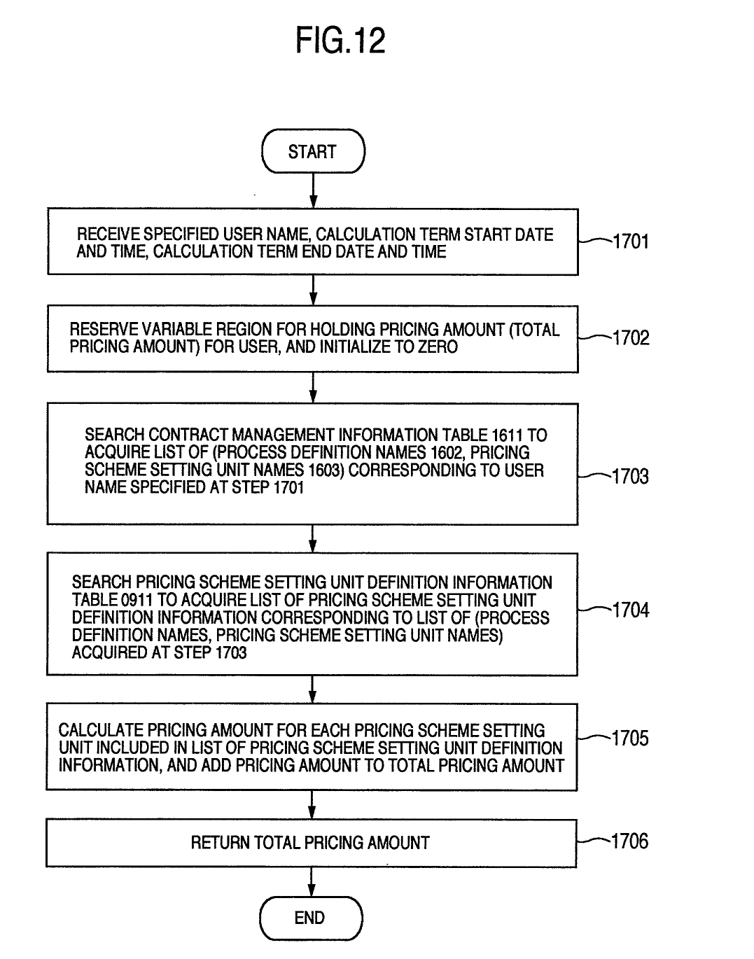

In the following, a detailed processing procedure of the pricing calculation program 0161 will be described with reference to a flow chart of FIG. 12.

In the processing procedure illustrated in FIG. 12, the pricing calculation program 0161 conducts pricing calculations for each pricing scheme setting unit 0801 indicative of a pricing scheme selected by the user, included in a process definition 0121 corresponding to a business process, for which the user has made a contract, from a user name, to determine a pricing amount for the user. In the following, each step will be described in detail along the flow. (Step 1701) The pricing calculation program 0161, when initiated, receives the specified user name subjected to the pricing calculation, and a term for which the pricing calculation is conducted (calculation term start date and time, and calculation term end date and time). (Step 1702) The program 0161 reserves a variable region for holding a pricing amount for the user (total pricing amount), and initializes the variable to zero. (Step 1703) The program 0161 searches the contract management information table 1611 to acquire a list of (process definition names 1602, pricing scheme setting unit names 1603) corresponding to the user name specified at step 1701. (Step 1704) The program 0161 acquires a list of pricing scheme setting unit definition information corresponding to the list of (process definition names, pricing scheme setting unit names) acquired at step 1703. (Step 1705) The program 0161 calculates a pricing amount for each pricing scheme setting unit in the list of pricing scheme setting unit definition information acquired at step 1704, and adds the pricing amount to a total pricing amount. Details on the processing at this step are similar to the processing which has been described in the first embodiment with reference to the flow charts of FIGS. 9A and 9B. (Step 1706) The program 0161 returns the total pricing amount to a caller, and terminates.

As described above, since the pricing scheme is defined associated with a business flow, this pricing scheme is readily understood by the user. In addition, since the pricing scheme can be defined for an arbitrary activity set in a business flow, the pricing scheme can be set in a meticulous manner by the provider.

Further, since the user can select a pricing scheme for each activity set, the pricing scheme can be customized in consideration of the characteristics of each business process.

Since the definition of the pricing scheme is associated with a business, the pricing scheme is readily understood by the user. Also, since a particular pricing scheme can be defined for an arbitrary activity set, the pricing scheme can be set in detail by the provider.

Further, since the pricing information is unitarily stored in the workflow execution history information, the provider can readily manage the pricing information.

Also, since the user can select a pricing scheme for each activity set, the pricing scheme can be customized in consideration of the characteristics of each business process.

It will be further understood by those skilled in the art that the foregoing description has been made on embodiments of the invention and that various changes and modifications may be made in the invention without departing from the spirit of the invention and scope of the appended claims.

What is claimed is:

1. A method of managing a workflow based on process definition information, comprising the steps of:
managing execution of a plurality of activities in a process based on process definition information, said process definition information defining said plurality of activities and a processing sequence between said plurality of activities, and holding execution history information on said plurality of executed activities;
corresponding an activity set included in a workflow defined by said process definition information to a pricing scheme for a user associated with the execution of said activity set, and holding the correspondence as activity set pricing definition information commonly applied for activity definitions included in said activity set; and
calculating a pricing amount for the user based on said activity set pricing definition information.

2. A workflow management method according to claim 1, further comprising the step of:
providing a relation, as an entry between each user and said activity set pricing definition information.

3. A workflow management method according to claim 1, further comprising the step of:
calculating said pricing amount using a history table having a record for execution of each said activity set, and a state management table for storing a state of the execution of said each activity set.

4. A workflow management method according to claim 3, further comprising the steps of:
providing a table for holding fee calculated in accordance with the number of times of passages in an activity set for execution; and
including fee pricing variable in said pricing amount.

5. A workflow management method according to claim 1, further comprising the steps of:
counting the number of times at least one activity set included in said workflow is passed for execution;
providing a memory for holding fee calculated in accordance with the number of times of passages for execution; and
including fee pricing variable in said pricing amount.

6. A workflow management method according to claim 1, further comprising the steps of:
providing a memory for holding an execution time for execution of at least one activity set included in said workflow; and
including fee pricing variable in said pricing amount.

7. A workflow management method according to claim 6, further comprising the step of:
defining a pricing scheme for a definition set including one or a plurality of activity definitions to be commonly applied thereto.

8. A workflow management method according to claim 7, further comprising the step of:
defining said pricing scheme for respective process definitions each coupled to an activity definition commonly when said process definitions are the same each other.

9. A workflow management method according to claim 1, further comprising the step of:
defining a pricing scheme for a definition set including one or a plurality of activity definitions to be commonly applied thereto.

10. A workflow management method according to claim 9, further comprising the step of:
defining said pricing scheme for respective process definitions each coupled to an activity definition commonly when said process definitions are the same each other.

11. A workflow management program which is read into and run on an apparatus for managing a workflow based on process definition information, said program comprising the steps of:
managing execution of a plurality of activities in a process based on process definition information, said process definition information defining said plurality of activities and a processing sequence between said plurality of activities, and holding execution history information on said plurality of executed activities;
corresponding an arbitrary activity set included in a workflow defined by said process definition information to a pricing scheme for a user associated with the execution of said activity set, and holding the correspondence as activity set pricing definition information; and
calculating a pricing amount for the user based on said activity set pricing definition information.

12. A workflow management program according to claim 11, further comprising the step of:
providing a pricing scheme setting unit name corresponding to a process definition name in a activity set for each user, as an entry, in said activity set pricing definition information.

13. A workflow management program according to claim 11, further comprising the step of:
calculating said pricing amount using a history table having a record for execution of each said activity set, and a state management table for storing a state of the execution of said each activity set.

14. A workflow management program according to claim 11, further comprising the step of:
defining a pricing scheme for a definition set including one or a plurality of activity definitions to be commonly applied thereto.

15. A workflow management program according to claim 14, further comprising the step of:
defining said pricing scheme for respective process definitions each coupled to an activity definition commonly when said process definitions are the same each other.

16. An apparatus for managing a workflow based on process definition information, comprising:
a CPU;
a workflow execution control engine for controlling execution of said workflow including a plurality of activity sets;
a table for holding execution history information on a plurality of activities in a process, associated with the execution of said plurality of activities based on process definition information, said process definition information defining said plurality of activities and a processing sequence between said plurality of activities; and
a table for corresponding an arbitrary activity set included in a workflow defined by said process definition information to a pricing scheme for a user associated with the execution of said activity set, and holding the correspondence as activity set pricing definition information,
wherein a pricing amount for the user is added based on said activity set pricing definition information.

17. A workflow management apparatus according to claim 16, wherein:
said activity set pricing definition information has a pricing scheme setting unit name corresponding to a process definition name in a activity set for each user as an entry.

18. A workflow management apparatus according to claim 16, further comprising:
a history table having a record for execution of each said activity set, and a state management table for storing a state of the execution of said each activity set,
wherein said workflow management apparatus calculates said pricing amount using said state management table.

19. A workflow management apparatus according to claim 18, further comprising:
a pricing scheme setting unit definition information table for holding the number of times counted for passages of at least one activity set included in said workflow for execution,
wherein said workflow management apparatus includes variable fee pricing in said pricing amount based on said table.

20. A workflow management apparatus according to claim 16, further comprising:
a first pricing scheme setting unit definition information table for holding the number of times counted for passages of at least one activity set included in said workflow for execution,
wherein said workflow management apparatus includes variable fee pricing in said pricing amount based on said table.

21. A workflow management apparatus according to claim 16, further comprising:
a second pricing scheme setting unit definition information table for holding an execution time for execution of at least one activity set included in said workflow
wherein said workflow management apparatus includes variable fee pricing in said pricing amount based on said table.

22. A workflow management apparatus according to claim 21, further comprising:
means for defining a pricing scheme for a definition set including one or a plurality of activity definitions to be commonly applied thereto.

23. A workflow management apparatus according to claim 22, further comprising:
means for defining said pricing scheme for respective process definitions each coupled to an activity definition commonly when said process definitions are the same each other.

24. A workflow management apparatus according to claim 16, further comprising:
means for defining a pricing scheme for a definition set including one or a plurality of activity definitions to be commonly applied thereto.

25. A workflow management apparatus according to claim 24, further comprising:
means for defining said pricing scheme for respective process definitions each coupled to an activity definition commonly when said process definitions are the same each other.

26. A storage medium having stored thereon a workflow management program in CPU readable codes, said workflow management program, when read into and run on an apparatus for managing a workflow based on process definition information, executing:
a code representing a step of managing execution of a plurality of activities in a process based on process definition information, said process definition information defining said plurality of activities and a processing sequence between said plurality of activities, and holding execution history information on said plurality of executed activities;
a code representing a step of corresponding an arbitrary activity set included in a workflow defined by said process definition information to a pricing scheme for a user associated with the execution of said activity set, and holding the correspondence as activity set pricing definition information; and
a code representing a step of calculating a pricing amount for the user based on said activity set pricing definition information.
